(19) United States
(12) Patent Application Publication
(10) Pub. No.: US 2011/0253758 A1
(43) Pub. Date: Oct. 20, 2011

(54) Bicycle rack accessory

(76) Inventor: Claude Bertrand, St-Basile-Le-Grand (CA)

(21) Appl. No.: 13/066,475

(22) Filed: Apr. 14, 2011

(30) Foreign Application Priority Data
Apr. 14, 2010 (CA) 2,699,962
Sep. 24, 2010 (CA) 2,715,563

(51) Int. Cl. B60R 9/10; B60R 9/06

(52) U.S. Cl. 224/519; 224/532; 224/536

(57) ABSTRACT

A bicycle carrier comprising an upwardly extending tube having a substantially horizontal tube connected thereto, a clamping mechanism for retaining a bicycle mounted on the horizontal tube, a display mounted on the tube, the display including a plurality of lights and a license display portion, and electrical interconnection between the lights and the electric wiring of the vehicle to which the bicycle carrier is to be attached.

### FIELD OF THE INVENTION

The present invention relates to a bicycle rack accessory and more particularly, relates to a display arrangement for use with a bicycle rack.

### BACKGROUND OF THE INVENTION

The use of bicycle racks for attachment to passenger vehicles is well known in the art. Bicycle racks which may be detachably secured to a conventional trailer hitch mounted on a passenger vehicle are numerous. Generally, the bicycle racks utilize a rectangular base tube that is received in the trailer hitch. Means are utilized for securing the tube in the hitch and the bicycle rack is secured thereto. The bicycle rack generally has some form of cross bar arrangement with a clamping arrangement utilized to hold the bicycle at one or more places.

The bicycle racks, as mentioned, will generally use a horizontal member which is designed to support a structural portion of the bicycle. The horizontal member will typically have a plurality of grooves and clamps associated therewith to transport between two and four bicycles. One of the problems associated with the carrying of a plurality of bicycles is that visual access to the directional lights of the vehicle is inhibited. This is dangerous since a vehicle following the one carrying the bicycles may not know of the intent of the preceding vehicle to turn or to stop.

One further problem, especially for law enforcement authorities, is the inhibiting of visual access to the license plate of the vehicle. Particularly when a plurality of bicycles are involved, it is usually difficult or impossible to view the license plate.

### SUMMARY OF THE INVENTION

It is an object of the present invention to provide a display member which may be utilized with bicycle racks to transfer information from the signal lights and a license plate to a position where visual access may be had thereto.

According to one aspect of the present invention, there is provided a bicycle carrier comprising an upwardly extending tube, a substantially horizontal tube connected to the upwardly extending tube, a clamping mechanism mounted on the horizontal tube, the clamping mechanism being arranged to receive and retain a structural portion of a bicycle, a display mounted rearwardly of the clamping mechanism on the horizontal tube, the display including a plurality of lights and a license display portion, and interconnecting means between the lights and the electrical wiring of a vehicle to which the bicycle carrier is to be attached.

According to a further aspect of the invention there is also provided a bicycle carrier comprising a first arm, the arm having a distal end, the distal end having a hook shaped configuration, a second arm, the second arm having a distal end with a hook shaped configuration, the first arm and the second arm being moveable with respect to each other to thereby change the distance between the first arm hook configuration and the second arm hook configuration, means for securing the first arm and the second arm together, and a display mounted on one of the arms, the display including a plurality of lights and a license display portion.

The display device of the present invention may be used with any type of bicycle rack. While some adjustments to mount the same may be required, most racks will have an end piece or other arrangement which can receive the display device.

The display device of the present invention will include at least two lights and as is conventional, these may utilize red lenses. Naturally, one may also utilize lenses of different colors such as orange and white. They may be hooked up to the wires of the vehicle which function for the turn indicators, four way flashers, and brake lights. The lights may have different intensities depending upon the purpose. Also, they may utilize different capacity bulbs depending upon the purpose for which they are signalling. More than two lights can also be utilized.

The display device will also include a display member which is designed to display the markings on the license plate. These may include numerals and letters as required. Various methods of doing the same may provide for temporary display or permanent display. In other words, the signage may be designed to be adjusted depending upon the license plate or alternatively, it may be permanently marked thereon.

The bike rack may take many different configurations. Thus, it may utilize a vertical tube along with a substantially horizontal tube connected thereto. The horizontal tube will normally carry a clamping mechanism which is arranged to receive and retain a structural portion of the bicycle. This structural portion is normally the top tube. Naturally, depending upon the particular clamping arrangement, other portions could be retained such as the down tube.

The display device may also be mounted in other different manners. Thus, for example, a clamping arrangement which is designed to fit between two horizontal tubes may likewise be utilized. Other arrangements will be shown in the detailed description.

A separate clamping device for presenting the desired information may be provided. This clamping device would be designed to clamp to any appropriate part of the bicycle to thereby present the desired information and signals. Preferably, in one embodiment, the device is rotatable such that it may be utilized at different angles.

The electrical connections would be similar to those utilized in pulling a trailer and which connections are well known. In one preferred embodiment, the wires may be run through the bicycle rack or carrier inside one or more of the structural components. A standard pin and socket arrangement may then be utilized to connect the display device.

### BRIEF DESCRIPTION OF THE DRAWINGS

Having thus generally described the invention, reference will be made to the accompanying drawings illustrating an embodiment thereof, in which:

FIG. 1 is a perspective view of a vehicle, bicycle rack with bicycle, and the display device;

FIGS. 2a and 2b are side elevational views of the bicycle rack and display device;

FIG. 3 is an end elevational view of the display device.

FIG. 4 is an exploded view of a portion of the bicycle rack of FIG. 5;

FIG. 5 is a perspective view of another embodiment of a bicycle rack;

FIG. 6 is a perspective view of a further embodiment of the present invention;

FIG. 7 is a perspective view of a bicycle rack using the display device of FIG. 6;

FIG. 8 is a rear perspective view thereof;

FIG. 9 is a top elevational view thereof;

FIG. 10 is a perspective view of a further embodiment of a display device according to the present invention;

FIG. 11 is a top plan view thereof;

FIG. 12 is a rear view illustrating movement of the placement of the device;

FIG. 13 is a perspective view of a further embodiment of the present invention;

FIG. 14 is a side elevational view, partially in section, of the device of FIG. 13;

FIG. 15 is a top plan view thereof; and

FIG. 16 is a rear view thereof.

### DETAILED DESCRIPTION OF THE INVENTION

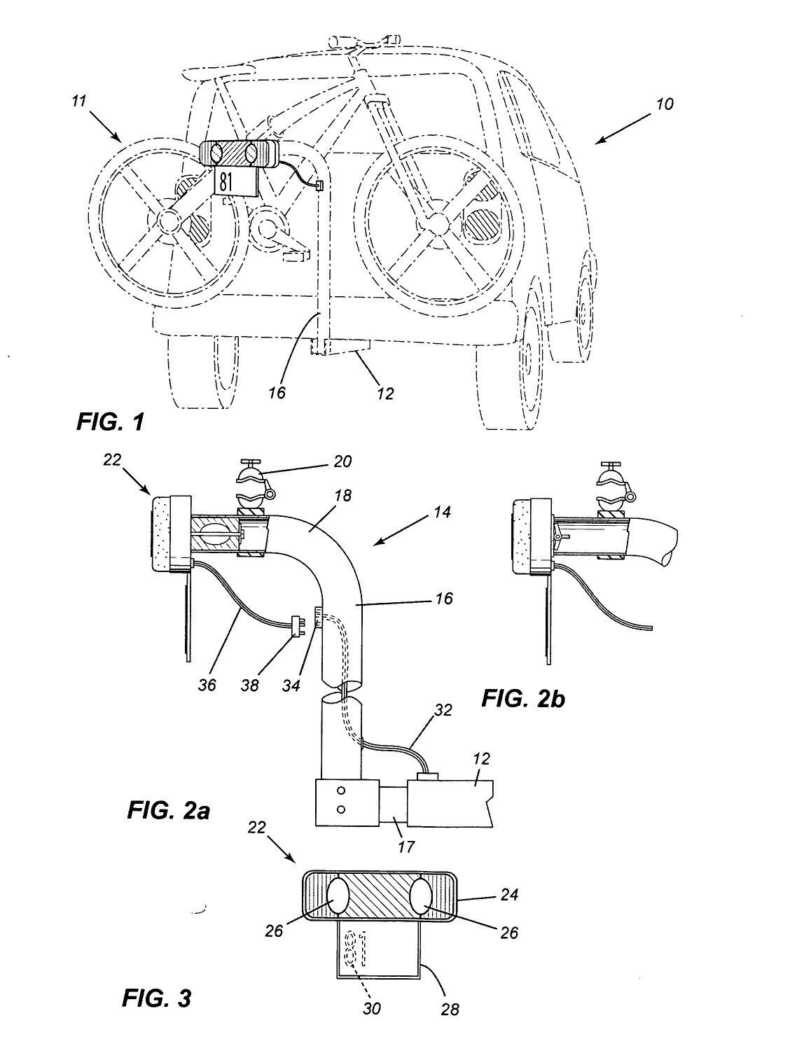

Referring to the drawings in greater detail and by reference characters thereto, there is illustrated in FIG. 1 a vehicle generally designated by reference numeral 10 and which vehicle 10 has a conventional trailer hitch 12. A bicycle rack generally designated by reference numeral 14 includes a vertical arm 16 meeting with an element 17 designed to fit within hitch 12. An upper horizontal arm 18 is designed to support a bicycle 11; the bicycle is retained by means of a clamp 20.

The display device of the present invention is generally designated by reference numeral 22 and includes a body 24 for housing the necessary electrical components. A pair of lights 26 are provided so that they are readily visible to any person rearwardly of the vehicle. Lights 26 are preferably operatively connected to the electrical system of the vehicle such that they can display turn signals, four way flashers and stopping lights.

A display plate 28 is designed to carry signage 30 which corresponds to the license plate of vehicle 10.

As may be seen in FIG. 2, wiring 32 from a wiring harness terminates in a receptacle 34. Receptacle 34 is preferably mounted on vertical arm 16 of bicycle rack 14. A plug 38 is designed to be received in receptacle 34 and wiring 36 extends to lights 26.

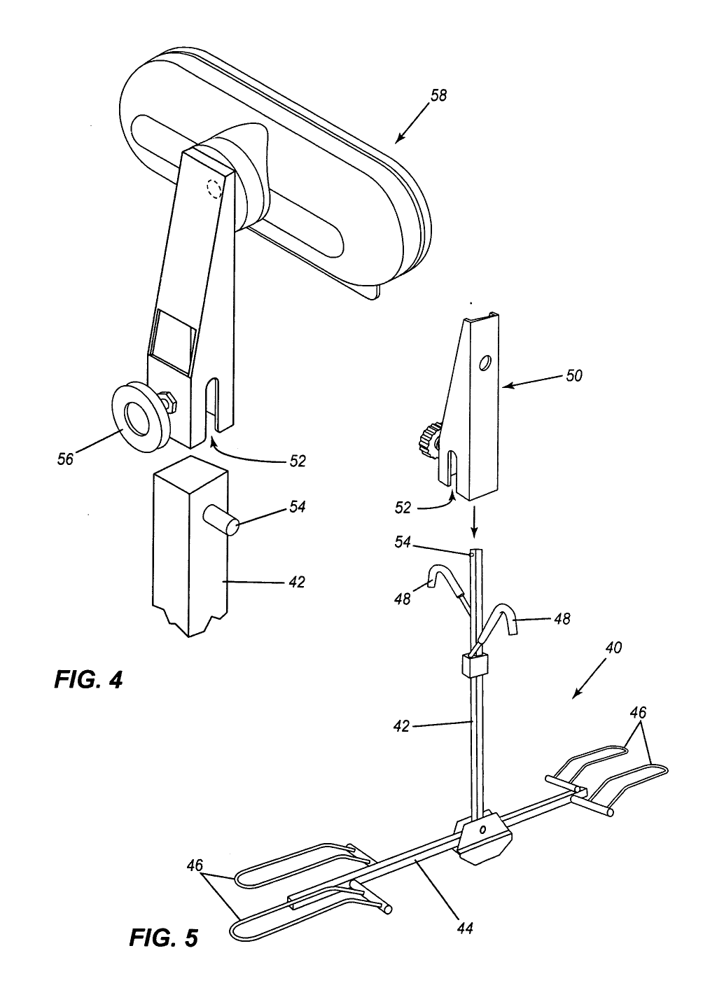

In the embodiment of FIGS. 4 and 5, there is illustrated a bicycle rack generally designated by reference numeral 40 and which includes an upwardly extending post 42 and a lower horizontal member 44. A pair of U-shaped elements 46 are provided for two bicycles—i.e. four wheels. A pair of retaining arms 48 will serve to secure the bicycle in position.

According to the present invention, there is provided a mounting member 50 which has a slot 52 and at least one side wall. It will be understood that both side walls may have such slots 50 to receive a pin 54 therein. A securing screw 56 will secure mounting member 50 to post 42. A display device 58 may then be mounted on the upper end of mounting member 50.

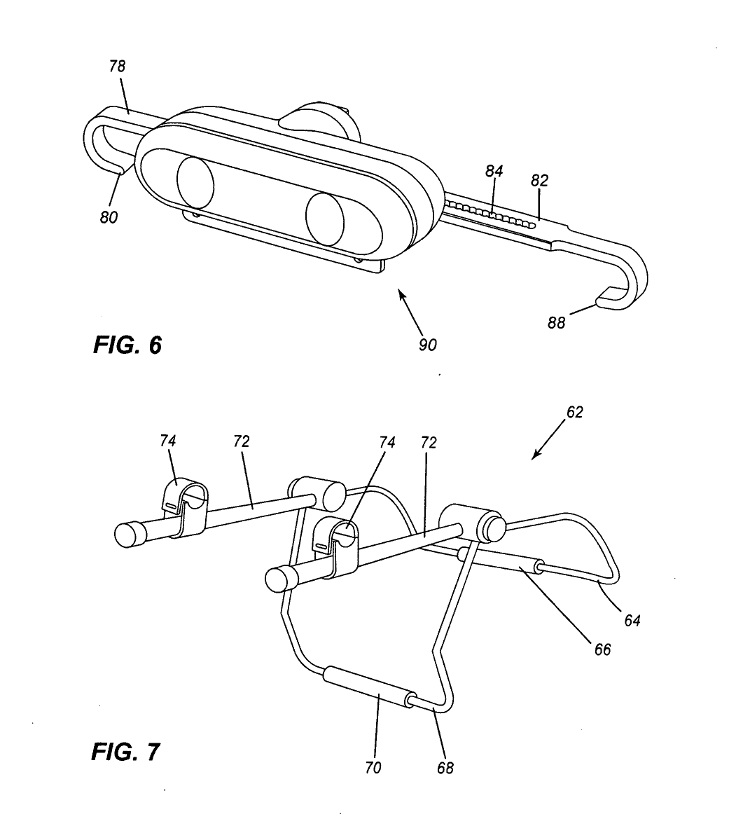

FIGS. 6 to 9 illustrate an embodiment which might be used with a trunk mounted bicycle rack 62. In a known configuration, bicycle rack 62 will include a front U-shaped portion 64 having a cushion 66 mounted thereon and a rear U-shaped portion 68 also having a cushion 70 mounted thereon. The rack includes a pair of rearwardly extending arms 72. Clamps 74 are provided thereon to receive a bicycle tube.

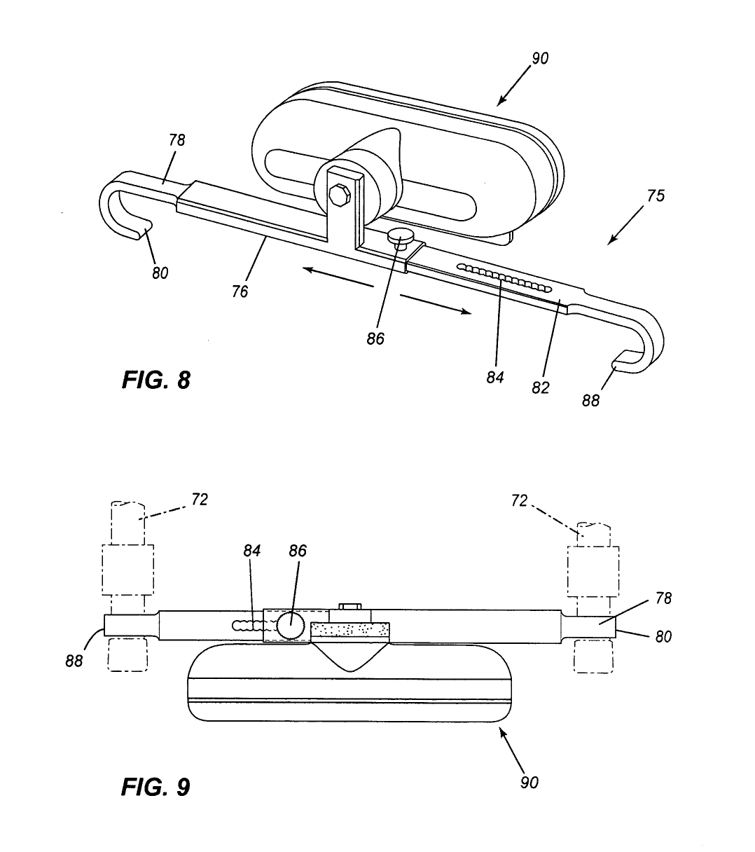

As shown in FIGS. 8 and 9, a clamping device generally designated by reference numeral 75 will include a body portion 76 having a first end 78 extending therefrom with a hook shape portion 80 at the end. A telescoping sliding member 82 is located at the other end and interfaces with main body 76. Member 82 includes a hook shaped portion 88 at one end thereof and an apertured portion 84 designed to receive a securing screw 86. As shown in FIG. 9, clamping arrangement 75 may be used to clamp on arm 72 irrespective of the distance between the arms.

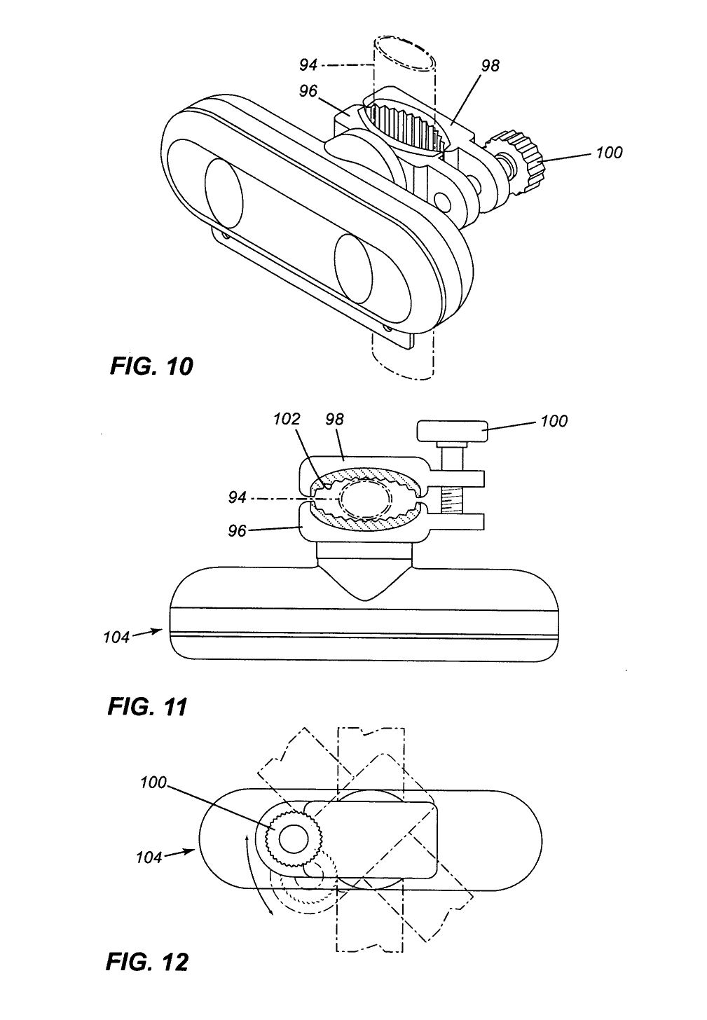

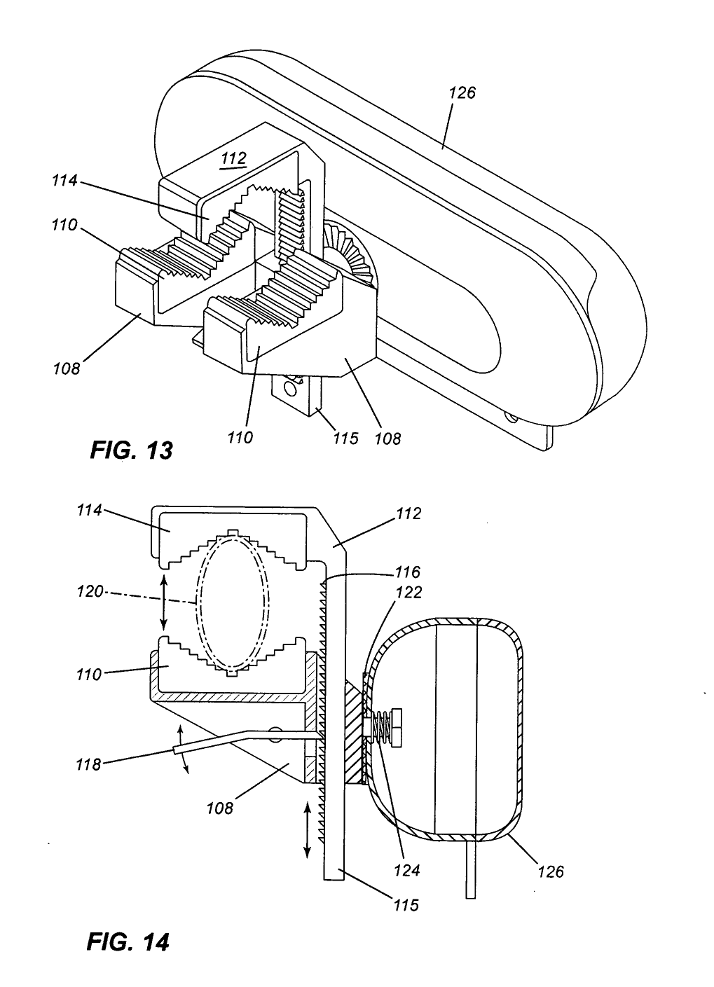

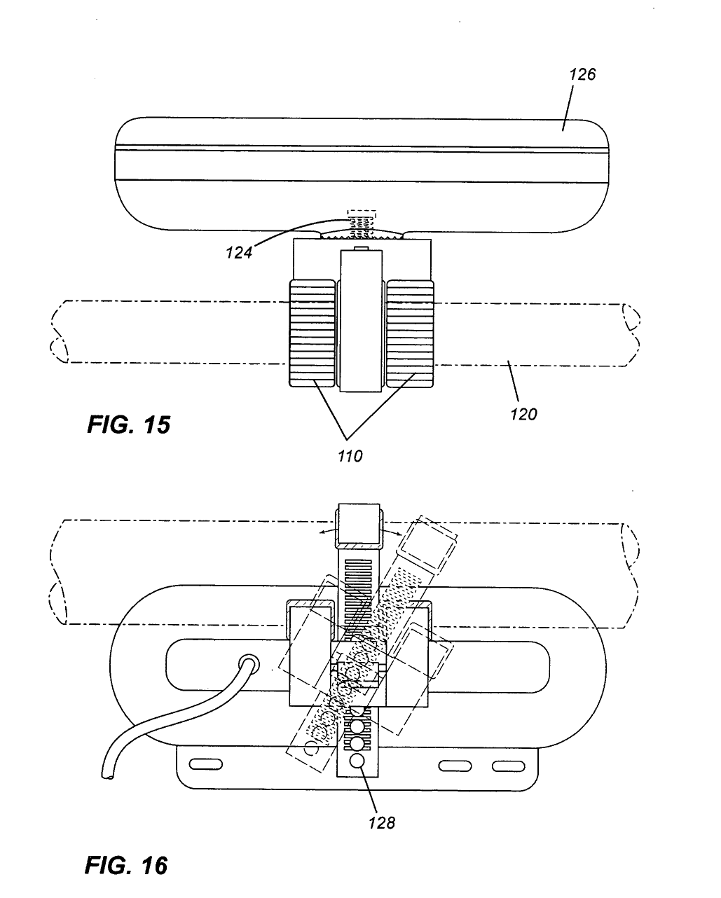

A further embodiment is illustrated in FIGS. 10 to 12. In this arrangement, a pair of clamp halves 96 and 98 are designed to be secured together by securing screw 100 and grip bicycle tube 94. As in the previous embodiments, a cushion/gripping liner 102 is employed and display device 104 mounted on clamp half 96. As seen in FIG. 12, display device 104 may be swiveled as will be discussed in the embodiment of FIGS. 13 to 16.

In the embodiment of FIGS. 13 to 16, there is illustrated an arrangement wherein there are a pair of lower clamps 108 having lower clamp inserts 110 therein. Inserts 110 form a gripping surface and conventionally may be of a rubber like material. An upper clamp 112 also has insert 114 therein. Upper clamp 112 has a downwardly extending leg 115 with a plurality of teeth 116 for gripping an opposed surface thereon. An adjustment member 118 is arranged to raise lower clamp 112 to grip bicycle tube 120.

A plurality of teeth 122 are formed facing an inner surface of display device 126. A spring member 124 is provided such that display device 126 may be rotatably adjusted with respect to the mounting portion. A plurality of locking apertures 128 may be provided at the bottom of leg 115 to receive a locking device.

In the embodiments of FIGS. 4 to 16, the necessary wiring and the like have not been shown; it is understood that arrangements similar to the embodiment of FIG. 1 may be used.

It will be understood that the above described embodiment is for purposes of illustration only and that changes and modifications may be made thereto without departing from the spirit and scope of the invention.

I claim:

1. A bicycle carrier comprising:
an upwardly extending tube;
a substantially horizontal tube connected to said upwardly extending tube;
a clamping mechanism mounted on said horizontal tube, said clamping mechanism being arranged to receive and retain a structural portion of a bicycle;
a display mounted rearwardly of said clamping mechanism on said horizontal tube, said display including a plurality of lights and a license display portion; and
interconnecting means between said lights and the electrical wiring of a vehicle to which said bicycle carrier is to be attached.

2. The bicycle carrier of claim 1 wherein said display comprises a light housing with said license display portion, said light housing having first and second lenses mounted thereon.

3. The bicycle carrier of claim 2 wherein said interconnecting means comprises wiring, said wiring extending through said vertical tube.

4. The bicycle carrier of claim 3 wherein there is provided an electrical socket on said vertical tube to receive a connecting mechanism associated with said display.

5. The bicycle carrier of claim 1 wherein said clamping mechanism comprises an upper jaw and a lower jaw, each of said jaws having a V-shaped recess formed therein, said upper jaw being moveable with respect to said lower jaw between a clamping and a non clamping position.

6. The bicycle carrier of claim 5 further including ratchet means to raise and lower said upper jaw between said clamping and non clamping positions.

7. A bicycle carrier comprising:
a first arm, said arm having a distal end, said distal end having a hook shaped configuration;
a second arm, said second arm having a distal end with a hook shaped configuration, said first arm and said second arm being moveable with respect to each other to thereby change the distance between said first arm hook configuration and said second arm hook configuration;
means for securing said first arm and said second arm together; and
a display mounted on one of said arms, said display including a plurality of lights and a license display portion.
